(19) United States
(12) Patent Application Publication
(10) Pub. No.: US 2023/0410656 A1
(43) Pub. Date: Dec. 21, 2023

(54) AUTONOMOUS CONTROL WITH ENCODED VISUAL SIGNALS

(71) Applicant: GM Cruise Holdings LLC, San Francisco, CA (US)

(72) Inventor: Siyuan Lu, San Mateo, CA (US)

(73) Assignee: GM Cruise Holdings LLC, San Francisco, CA (US)

(21) Appl. No.: 17/842,527

(22) Filed: Jun. 16, 2022

(51) Int. Cl. G08G 1/16

(52) U.S. Cl. CPC G08G 1/166; G08G 1/163

(57) ABSTRACT

To provide control for an autonomous vehicle based on a physical object near an autonomous vehicle (AV), the AV monitors its environment with an imaging sensor, such as an infrared sensor or visible light camera. The imaging sensor captures a sensor view of the environment and an encoded signal is detected in the sensor view. The encoded signal may be emitted by a mobile device with a respective emitter for the imaging sensor, such as an IR emitter or a visual light source. After detecting the encoded signal, the AV identifies the location of the mobile device within the sensor view and the environment. Then, based on the determined location in the environment, the AV performs a control action, such as navigating to a stopping place near the location.

### BACKGROUND

This disclosure relates generally to controlling an automated vehicle, and more particularly to identifying encoded signals and identifying the location associated with the encoded signal for the control of the autonomous vehicle.

For autonomous vehicles, navigating in complex spaces, particularly coordinating with other vehicles and in the presence of many users, it may be difficult to precisely navigate the autonomous vehicle to identify, for example, a particular person who is a passenger for a particular vehicle. For example, at a stadium or other event venue, many users may have requested rides for vehicles in a designated pick-up area and it may be difficult for each vehicle to determine the appropriate place to stop for the respective rider of the vehicle. In some circumstances, a user is informed of an identifier of the vehicle (for example, a number or license plate of the vehicle for that rider), however, the vehicle itself is not typically informed of the particular location of its passenger with precision or with respect to its own position or sensors. As such, the vehicle may stop without regard to the actual position of the user and may cause confusion in which vehicles and users are not successfully coordinated.

### BRIEF DESCRIPTION OF THE DRAWINGS

FIG. 1 shows example components of an autonomous vehicle, according to one embodiment.

FIG. 2 shows components of the control system, according to one embodiment.

FIG. 3 shows an example environment in which encoded signals may be used to control respective autonomous vehicles, according to one embodiment.

FIG. 4 shows a sensor view from an AV in which encoded signals are detected, according to one embodiment.

FIG. 5 is an interaction diagram between a mobile device and an AV, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

To identify and navigate to a user, or otherwise provide control based on a physical object near an autonomous vehicle (AV), the AV monitors its environment with an imaging sensor, such as an infrared sensor or visible light camera. The imaging sensor captures a sensor view of an environment, which is monitored for an encoded signal. The encoded signal may be emitted by a mobile device with a respective emitter, such as an infrared (IR) emitter or a visual light source. After detecting the encoded signal, the AV identifies the location of the mobile device within the sensor view, and the location of the mobile device with respect to the environment. Then, based on the determined location in the environment, the AV performs a control action, such as navigating to a stopping place near the location. The encoded signal may be specific to a particular user or a particular trip and exchanged between the mobile device and the AV to coordinate recognition of the signal.

As the AV approaches the location of the mobile device, the mobile device may notify the user to activate the encoded signal and move the mobile device to a position viewable from the perspective of the approaching AV. When the AV detects the encoded signal emitted from the mobile device, the AV may then navigate to stop near the mobile device. In one embodiment, the AV uses the encoded signal for access control to the AV. When the user brings the mobile device within a threshold distance of the AV, the AV may then provide access to a passenger cabin or other portion of the AV. In additional embodiments, the encoded signal may also be used for other purposes and other types of actions, for example, police or other emergency vehicles, may have an associated encoded signal that may be used to control additional actions or the AV, such as moving to a location or avoiding the location of the mobile device. The AV may maintain a set of registered signals for different types of control (e.g., by different entities). When a received encoded signal matches a registered signal, the match may indicate authorization to perform a control action.

By providing different mobile devices with different signals, the AV can disambiguate different users and different actions that are affected by the detected location of the mobile devices. As a result, different encoded signals from different users may allow for different control for different users or for different AVs.

Additional details and variations of these aspects are further discussed in detail below.

As will be appreciated by one skilled in the art, aspects of the present disclosure, may be embodied in various manners (e.g., as a method, a system, a computer program product, or a computer-readable storage medium). Accordingly, aspects of the present disclosure may be implemented in hardware, software, or a combination of the two. Thus, processes may be performed with instructions executed on a processor, or various forms of firmware, software, specialized circuitry, and so forth. Such processing functions having these various implementations may generally be referred to herein as a “module.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units and in a different order, unless such an order is otherwise indicated, inherent, or required by the process. Furthermore, aspects of the present disclosure may take the form of one or more computer-readable medium(s), e.g., non-transitory data storage devices or media, having computer-readable program code configured for use by one or more processors or processing elements to perform related processes. Such a computer-readable medium(s) may be included in a computer program product. In various embodiments, such a computer program may, for example, be sent to and received by devices and systems for storage or execution.

This disclosure presents various specific examples. However, various additional configurations will be apparent from the broader principles discussed herein. Accordingly, support for any claims which issue on this application is provided by particular examples, as well as such general principles, as will be understood by one having ordinary skill in the art.

In the following description, reference is made to the drawings where like reference numerals can indicate identical or functionally similar elements. Elements illustrated in the drawings are not necessarily drawn to scale. Moreover, certain embodiments can include more elements than illustrated in a drawing or a subset of the elements illustrated in a drawing. Further, some embodiments can incorporate any suitable combination of features from two or more drawings.

As described herein, one aspect of the present technology may be the gathering and use of data available from various sources to improve quality and experience. The present disclosure contemplates that in some instances, this gathered data may include personal information. The present disclosure contemplates that the entities involved with such personal information respect and value privacy policies and practices.

The following disclosure describes various illustrative embodiments and examples for implementing the features and functionality of the present disclosure. While particular components, arrangements, or features are described below in connection with various examples, these are merely examples used to simplify the present disclosure and are not intended to be limiting.

Reference may be made to the spatial relationships between various components and to the spatial orientation of various aspects of components as depicted in the attached drawings. However, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having,” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” generally refers to an inclusive use of “or” (including combinations of listed elements) rather than an exclusive use of “or” (exclusive selection of one element) unless expressly indicated or otherwise inherent to the use of “or.”

### System Overview

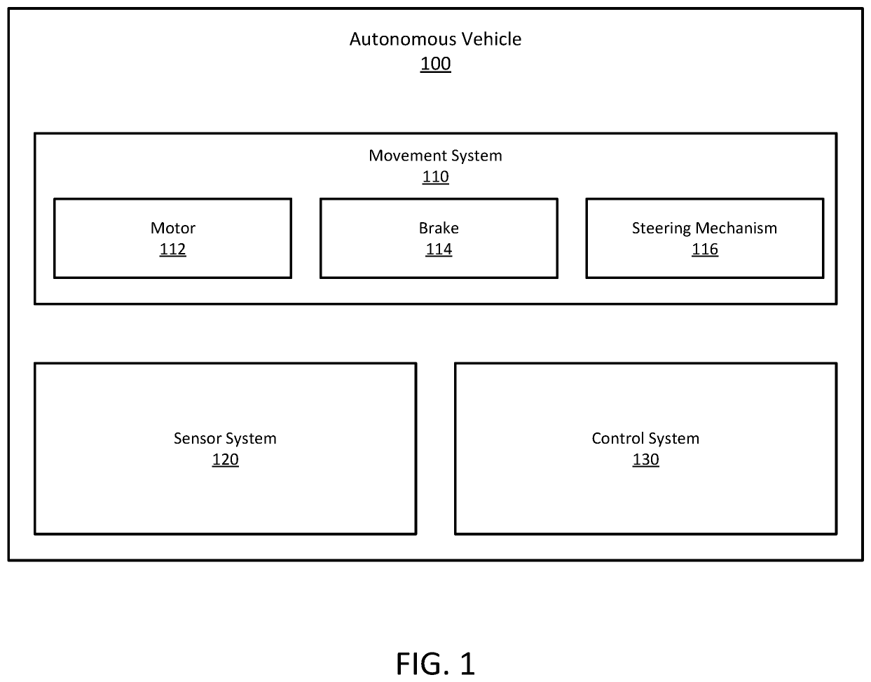

FIG. 1 shows example components of an autonomous vehicle 100, according to one embodiment. In general, an autonomous vehicle 100 includes a movement system 110 to affect physical movement of the autonomous vehicle 100 within an environment surrounding the vehicle, a sensor system 120 that includes a set of sensors for capturing information about the movement of the autonomous vehicle 100 and receiving information about the environment, and a control system 130 that perceives the environment and provides control to the movement system 110 for moving the autonomous vehicle 100 within the environment. In various embodiments, the autonomous vehicle 100 may be completely autonomous and the movement system 110 may be controlled without manual user operation, and in other embodiments may be partially autonomous, such that certain functions or features are automatically provided by the control system 130. In other instances, a user may manually control operation of the movement system 110, for example, through various types of manual control mechanisms or inputs, such as pedals, steering wheel, gearbox control, etc. Such manual operation may be provided by an occupant of the autonomous vehicle 100 or may be provided remotely via a communication link to an external operator. In some embodiments, the autonomous vehicle 100 may transition operation to modes with more or less autonomous control based on various conditions, such as a user request, vehicle conditions, or environmental conditions. The autonomous vehicle 100 may also operate with or without an occupant in various embodiments or may activate or deactivate autonomous functions based on occupancy. In some embodiments the autonomous vehicle 100 may include no passenger cabin.

The movement system 110 includes various components for affecting movement of the autonomous vehicle 100 in the environment. As such, the movement system 110 may include a motor 112 that may be connected to a drive system (e.g., wheels) that moves the autonomous vehicle 100. The motor 112 may have multiple operation modes for moving forward, backward, or set to neutral, and may also be set to different speeds/torques (e.g., via various gear ratios). The motor 112 may also be capable of different levels of power output as controlled by a throttle. The movement system 110 may also include a brake 114 for slowing or stopping the movement of the autonomous vehicle 100 along with a steering mechanism 116 for changing the direction of travel of the autonomous vehicle 100. In general, the particular implementation of the components of the movement system 110 enables the autonomous vehicle to start, stop, and change direction in its environment, and may vary according to the particular type of the autonomous vehicle 100. Generally, the movement system 110 thus represents the mechanical components for movement and are controlled by signals received from the control system 130 that designate, for example, an amount of output by the motor, a steering direction for the steering mechanism 116, and so forth.

The sensor system 120 includes a set of sensors for monitoring the autonomous vehicle 100 and the environment around the autonomous vehicle 100. The particular set of sensors and the arrangement thereof may vary according to different examples. As examples, the sensors may include various sensors for monitoring the mechanical performance of the autonomous vehicle 100, such as sensors for monitoring motor performance, fluid levels, air pressure, wheel rotation speed, etc.

The sensors may also include various sensors for localization of the autonomous vehicle 100 within the environment and for perceiving the environment of the autonomous vehicle 100. In general, these sensors may capture various types of modalities of information, such as audio, video, and various electromagnetic frequencies. The sensors may include passive (e.g., receipt-only) and active sensing technologies (e.g., environmental scanning with active transmission and receipt of a return signal). Although certain sensors are discussed here, in practice, more or fewer sensors may be included according to the particular configuration of the various embodiments. The sensors may include one or more imaging sensors, which may include visible-light imaging sensors (e.g., a camera) or an IR imaging sensor, radio detection and ranging (RADAR) sensors, or light detection and ranging (LIDAR) sensors. The sensors may also include a receiver for global positioning satellite (GPS) location data, a compass, and receivers for wireless signals, such as cellular or other wireless networks. The sensors may also include receivers for various electromagnetic (EM) signals in various frequencies along with microphones for receipt of audio and other sound information from the environment.

Each sensor may also capture information in respective data formats and modalities according to the capacities of the sensors. For example, an imaging sensor typically captures received light as a two-dimensional image having one or more channels. As such, a visible light camera typically describes color images with color channels in an image space (e.g., as values of red-green-blue, hue-saturation-lightness, hue-saturation-value, cyan-yellow-magenta-key, etc.), while an infrared camera may describe received infrared frequencies in one channel. Similarly, audio capture with a microphone may be described as a frequency waveform, while RADAR/LIDAR data may be represented as a point cloud of data points representing the environment as points at varying distances from the sensor.

The position and placement of the sensors may also vary according to different embodiments and may be calibrated with respect to characteristics of each individual sensor and also with respect to one another to determine the relative position and orientation of each sensor to translate information captured from each sensor to a joint coordinate system. This may permit data from multiple sensors to be aligned to a common coordinate system such that information from multiple sensors may be jointly interpreted.

The sensors may also include various sensors for perceiving the internal condition of the autonomous vehicle 100, such as a microphone to receive any noises or audible instructions from a passenger within the vehicle or a camera for viewing the passenger cabin.

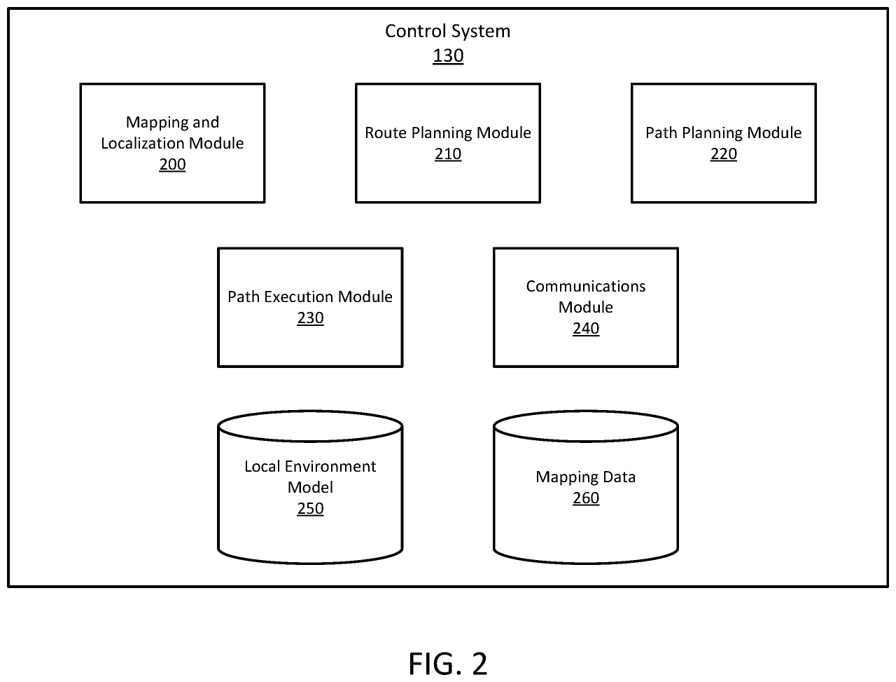

The control system 130 receives sensor data from the sensor system 120 and generates signals for the control of the components of the movement system 110 to navigate the autonomous vehicle 100 within its environment. The control system 130 thus may include components for perceiving the environment based on the sensor data, planning movement, and executing movement with control signals. The control system 130 is further discussed in FIG. 2.

Although generally the autonomous vehicle 100 refers to a vehicle typically operated on a road, such as a car, light truck, heavy truck, principles of this disclosure may also apply to other types of autonomously- or partially-autonomously-operated vehicles. Such additional types of autonomous vehicles 100 may include aerial vehicles such as drones, helicopters, or planes, as well as aquatic vehicles including surface and sub-surface vehicles. As such, the principles discussed herein may generally apply to systems that sense environmental information, analyze and perceive aspects of the environment, and/or provide for automated control of the autonomous vehicle 100.

Not shown in FIG. 1 are various additional components that may be included in various embodiments and are omitted for the purpose of simplifying the discussion herein. For example, the autonomous vehicle 100 may include lights (e.g., headlights, brake lights, etc.), signaling mechanisms, access control (e.g., door locks), battery, fuel storage, and other suitable components.

FIG. 2 shows components of the control system 130, according to one embodiment. The control system 130 includes various components for processing sensor data to perceive the environment of the autonomous vehicle 100 and provide control signals to the movement system 110. The control system 130 may include various computing modules and data storage elements. To perceive and understand the environment, a mapping and localization module 200 may generate and maintain a local environment model 250 that describes conditions of the current environment around the autonomous vehicle 100, such as various objects perceived in the environment based on received sensor data and in conjunction with a set of mapping data 260. Additional modules, such as a route planning module 210, a path planning module 220, and a path execution module 230, determine and execute long- and short-term movement planning. Finally, a communications module 240 may communicate with external systems, both to coordinate movement of the autonomous vehicle 100 and to update software and data components.

In further detail, the mapping and localization module 200 determines and maintains the local environmental model 250 and may implement an environment perception stack for identifying objects and characteristics of the environment. The local environment model 250 may thus describe individual objects in the environment, e.g., objects, people, trees, signs, etc., in a virtual model of the environment consistent with the sensor data. The position of the objects relative to one another along with a current velocity (e.g., with respect to other objects, non-moving/background objects, or the autonomous vehicle 100) may be characterized in the local environmental model 250. The mapping and localization module 200 may also predict future movement of the perceived objects at various timeframes based, e.g., on the current velocity, as well as other sensed data that may predict future change in heading or intention by the object. As such, while the current velocity of a detected object may be expected to continue for at least a short timeframe (e.g., 50 ms), over longer timeframes the objects may be predicted to continue at that heading and speed, slow down, speed up, change direction, and so forth. For example, when a “stop” sign is in the environment ahead of a vehicle, the vehicle may be expected to change its speed to reduce speed and likely stop in the vicinity of the stop sign. The expected movement of objects at different timeframes may thus be predicted with different levels of confidence and may be probabilistically represented according to different types of actions that may be inferred for moving objects. For example, a pedestrian on a street corner may continue to stand at the corner or may, at some future time, enter the street to cross.

To build and update the local environment model 250, the mapping and localization module 200 may process the received data from the various sensors and apply object recognition, motion prediction, and localization algorithms. That is, the mapping and localization module 200 determines objects in the environment, predicts how those objects may move, and determines the location of the autonomous vehicle 100 in relation to the environment. The state of the local environment may thus be stored as the local environment model 250.

To describe the local environment, the sensed information may be processed by various algorithms for perception and object detection. The various sensor data may be individually processed as well as processed in combination with other sensor data of the same or different types. For example, in some embodiments, multiple image sensors may overlap in the portions of the environment viewable by the respective sensors. The captured images may be stitched together to form a larger image for the combined regions, and the respective difference in apparent size and position of an object from the cameras may also be used to infer distance to the object from the images. In some embodiments, imaging sensors may be disposed around the autonomous vehicle, such that the captured images may be merged to form a panoramic view of the environment. In addition, the captured image data and other sensor data (e.g., RADAR and LIDAR point cloud data) may be processed by one or more neural networks for object segmentation and identification. These networks may perform processing on sensor data individually (e.g., initial object identification based on image or LIDAR data alone) and may include networks (or network layers) for joint processing of multiple sensor types together. The current local environment model 250 may also be sequentially generated and updated at a frequency based on the sensor information since the last update. As such, each local environment model 250 may represent a “frame” of the perceived environment. In addition, the current local environment model 250 may also account for prior captured sensor data (e.g., of a prior frame) and prior frames of the local environmental model in constructing a current local environment model 250. This may permit, for example, object and motion tracking over time to improve object classification as well as movement prediction and to account for objects which may be temporarily obscured by other objects. In some embodiments, the construction and maintenance of the local environment model 250 may be performed based on the captured sensor data by the sensor system 120.

The environment mapping may also be performed in conjunction with information from the mapping data 260. The mapping data 260 stores longer-term data about various regions that may be used for localization and route planning. For example, the mapping data 260 may include roads, landmarks, coordinates, road signs and other road control information, and various other information associated with a mapping of the world that is generally expected to be relatively stable over time. Detected objects and other sensor data may be used to determine the position of the autonomous vehicle with respect to the known information in the mapping data 260. For example, the GPS location information may be used to determine the likely position of the vehicle with respect to the mapping data 260. However, as GPS location information may be distorted or imprecise, particularly when navigating environments with many buildings or other interference, additional information may be used to synchronize the perceived environment with the mapping data 260. For example, locally-perceived objects and other signatures of the environment may be matched with known landmarks and characteristics in the mapping data 260. After determining the location of the autonomous vehicle with respect to the mapping data 260, the local environment model 250 may also be supplemented with information from the mapping data 260, for example, to provide information about areas of the environment beyond the perception range of the sensors of the sensor system 120. This information may be useful, for example, for longer-term motion planning or movement prediction of other objects. For example, the sensors may perceive objects that obscure road signs from the sensor system 120 that may be known or expected in the environment based on the mapping data 260.

The local environment model 250 may also be used to update the mapping data 260 when the locally-sensed data differs from the mapping data 260. For example, the sensor data may not perceive a road sign at a location designated in the mapping data 260 despite a view of that location, or a road may be closed or under construction or otherwise in a different condition than designated in the mapping data 260. The mapping and localization module 200 may communicate differences between the mapping data 260 and the locally-perceived environment to an external system that maintains the mapping data 260.

The route planning module 210 determines longer-range planning and routing for the autonomous vehicle 100 and may determine, for example, an expected navigation route from an origin to a destination. Conceptually, the route planning module 210 may determine the high-level navigation objective and route, in contrast to the path planning module 220, which may determine short-term navigation with respect to the local environment model 250. While discussed here as separate components, in practice, these components may be jointly implemented, and the longer-term route planning may be affected by information discovered from the local path execution or environmental perception. For example, a planned route may indicate travel along a road that the local environment model 250 indicates is not available or for which there is no executable path to reach, such that another destination or route must be determined.

The route planning module 210 may determine the current location of the autonomous vehicle 100 and a destination and the overall route (e.g., individual roads and turns) to arrive at the destination from the current location. The route may be determined by available ways to reach the destination from the origin and evaluated with respect to traversal costs such as expected travel speeds, fuel usage, time, ride smoothness/passenger comfort, traffic, and so forth. The available ways of reaching the destination may be explored by various traversal algorithms based on the costs of traversing different routes and cost preferences for combining different types of costs.

The route planning module 210 may also receive instructions from an external system specifying a route or a destination. For example, the external system may coordinate destinations for many autonomous vehicles, such as destinations for passenger or cargo pickup/delivery, for vehicle maintenance or refueling, and so forth. The destination and/or a route for reaching the destination may thus be determined by the route planning module 210 or provided by the external system.

The path planning module 220 determines a path for navigating the local environment based on the local environment model 250 and the desired route specified by the route planning module 210. As such, the route from the route planning module 210 may provide a route indicating that the autonomous vehicle should turn right at the next street in approximately two miles. The path planning module 220 evaluates objects in the local environment (e.g., other cars, pedestrians, etc.) and determines the desired path for the autonomous vehicle 100 to navigate to and execute the turn. This may include, for example, changing lanes to a turn lane based on available space in the turn lane, stopping at the intersection, executing the turn, and so forth.

The path planning module 220 may look ahead an amount of time in predicting the movement of objects during its planning and update the planned path for each frame that the local environment model 250 is updated. The path planning module 220 may thus provide desired speed, turning, and other information to the path execution module 230 for execution.

The path execution module 230 executes the path with the various movement control signals for the movement system 110 to execute. Such signals may control application of the throttle, brake, and steering to execute the planned path. The path execution module 230 may include feedback mechanisms for verifying expected execution of the signals by the movement system 110, for example, to confirm a wheel-speed sensor is affected by application of the brake or throttle or that the specified speed along the path is achieved by the applied throttle signal. As such, the path execution module 230 translates the higher-level path instructions to specific signals that control the physical components of the movement system 110.

The communications module 240 coordinates messaging with other systems and devices. As one example, the communications module 240 may be used for updating the mapping data 260 based on data kept by an external data source. As another example, the communications module 240 may provide diagnostic, operations, and safety information for monitoring of the autonomous vehicle 100. As such, the communication module 240 may use respective communication components (e.g., transceivers) for various communication modalities such as cellular or wireless communications.

The control system 130 may include additional modules or components for control and management of the autonomous vehicle 100 that are not explicitly shown here. For example, the control system 130 may include voice recognition and control components for interpreting commands by a passenger, a module for coordinating communication of the passenger with a remote technician via the communications module 240, and modules for operating various other features or components of the autonomous vehicle 100.

Control with External Signals

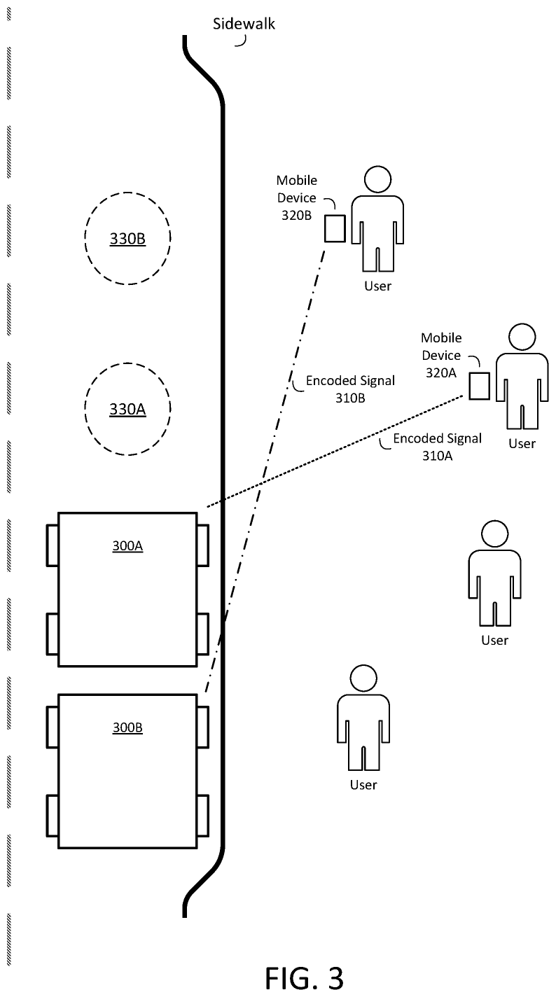

FIG. 3 shows an example environment in which encoded signals 310A, B may be used to control respective autonomous vehicles 300A, B, according to one embodiment. As shown in this example, autonomous vehicles 300 (which may include embodiments of AV 100) may travel to congested environments that include several AVs and users (who may be intended passengers of the AVs) are present. While a route may be planned to pick up a particular passenger in a particular location with a particular destination, often the locations may be congested with many users. As such, the respective AVs 300A, B, may identify and navigate to respective destinations 330A, B based on the determined locations of users' mobile devices 320A, B. To signal each AV 300A-B and help each AV 300A-B identify the correct location, the users may use a mobile device 320A-B to generate respective encoded signals 310A-B that provide signaling to the AVs 300A-B.

The encoded signals are coded to represent a particular value or identifier that may be received by the AV 300. The mobile device 320 communicates the signal to the AV 300 with a beacon, such as an infrared (IR) or visual emitter (e.g., a flashlight or portion of a display) that can be perceived by a respective imaging sensor on the autonomous vehicle (e.g., an IR or visual light sensor). In general, the beacon may emit a bright-enough signal that may be perceived and identified by the AV 300 from a sufficient distance, such as 5, 10, 15, 20, or 30 meters. In various embodiments, the particular type of beacon for emitting the signal may depend on the available types of emitters on the mobile device 320. In some examples, the mobile device 320 is a mobile phone or other communications device that may have different types of emitters which may vary according to the particular type of device, such that the selected emitter to be used as the beacon may depend on which emitters are available on the device. In other embodiments, additional types of devices, such as dedicated signaling devices, may be used as the mobile device 320.

In one embodiment, the encoded signal 310 is a sequence of activations of the beacon with different pulse lengths or frequencies that signify different values (e.g., encoding individual bits having a value of zero or one). From the perspective of the sensor on the autonomous vehicle 300, activation of the beacon may appear as a detectable “flash” in the sensor view of the sensor capturing the image. The AV 300 may decode the encoded signal 310 according to the encoding scheme to recover the value transmitted by the mobile device 320. In additional embodiments, other types of encoding may be used. For example, in embodiments in which the display of the mobile device 320 is used to provide the encoded signal 310, rather than flashing at different frequencies the display may provide a quick response (QR) code or other visual code that may be perceived by the AV 300. In general, the mobile device 320 may be positioned by the user in a location to be viewed by the AV 300 (e.g., above the user's head or above a crowd).

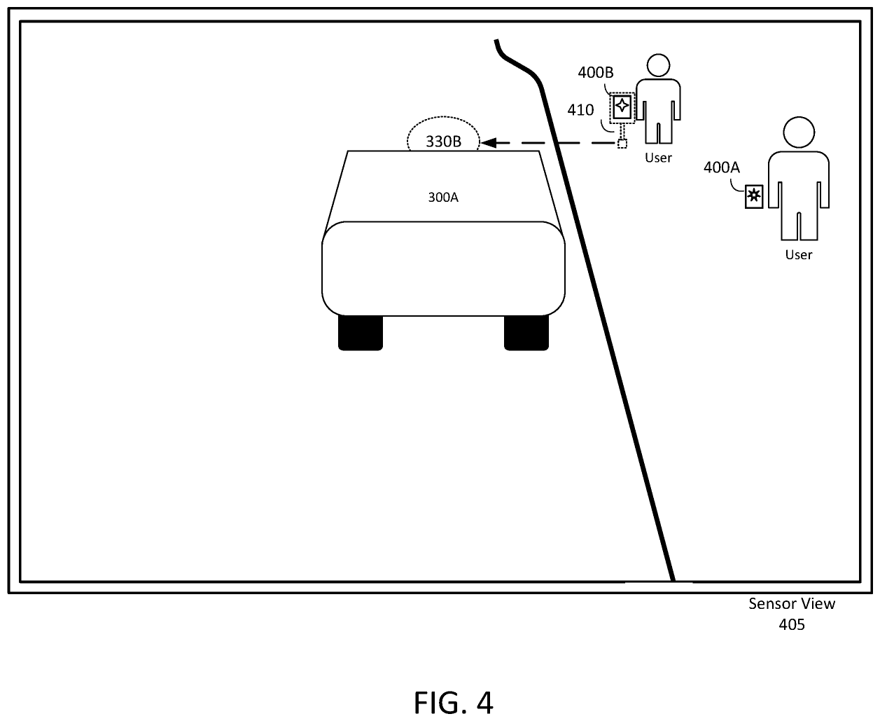

FIG. 4 shows a sensor view 405 from an AV in which encoded signals 400 are detected, according to one embodiment. FIG. 4 illustrates the sensor view 405 from the AV 300B shown in FIG. 3. In this example, the sensor view 405 (e.g., from an IR sensor of the AV 300B) may detect the encoded signals 400A and 400B from respective IR emitters on the users' mobile devices 320A, B. Encoded signals 400A, B represent the detected signals in the sensor view 405 of the respective encoded signals 310A, B shown in FIG. 3 as emitted from the mobile devices 320A, B. To identify the encoded signals 400A, B, the sensor view 405 from the imaging sensors on the AV (here, AV 300B) may be analyzed by the mapping and localization module 200 to identify and monitor the position of a detected signal across captured frames of the imaging sensor. This permits identification of the signal (e.g., to decode the value) and determining the position of the signal within the sensor view. Because the signals are encoded, the particular code emitted from each device may be used to distinguish the different mobile devices from the perspective of the AV based on its own sensor view. This permits control of each AV 300 by respective mobile devices using visual signaling to indicate a location of the mobile device and may be effective even in crowded spaces with several mobile devices.

In this example, the sensor view 405 of AV 300B may identify the encoded signals 400A, B in the sensor view and determine whether the received encoded signal(s) 400A, B match with a set of registered signals permitted to control the AV 300B. Each registered signal may indicate an encoded signal authorized to affect control of the AV and may also be associated with a particular control action to be performed by the AV when the registered signal is detected. As such, matching the received signal to the registered signals may be used to verify the particular registered signal is allowed to control the particular AV. Signals may be added or removed from the set of registered signals by communication with an external system (e.g., a system that coordinates travel of the AVs to various users and destinations), and in some embodiments may be directly communicated by the mobile device 320 with the respective autonomous vehicle 300. For example, in some embodiments the autonomous vehicle 300 may include networking communication capabilities and be directly addressable to and from the mobile device 320, such that an authorized mobile device may directly send a signal to be registered to the autonomous vehicle 300. In this example, the AV 300B matches the received encoded signal 400B with a registered signal, while the received encoded signal 400A is not matched and may be discarded.

After identifying one of the signals in the sensor view that matches a registered signal, the AV may identify the location 410 of the mobile device emitting the signal and perform a control action based on the location 410. In the example of FIG. 4, the control action is the selection of a stopping point 330B (e.g., a precise destination) for the autonomous vehicle 300B. As such, when the control signal is identified and matched by the localization and mapping module 200, the location 410 of the mobile device emitting the matched signal is determined based on the local environment model 250. In some circumstances, the encoded signal 400 may be determined with one type of sensor, and the location 410 of the mobile device may be determined based on information from another sensor. For example, the encoded signal 400 may be detected in an IR sensor view, and the location of the mobile device emitting the signal may be correlated with information from a LIDAR point cloud to more precisely determine a distance of the mobile device from the AV and the location of the device in three-dimensional space. In this example, the control action is to determine the stopping point 330B based on the location 410; the stopping point 330B may then be set as the route destination and navigated to by the path planning module 220. As such, the user may conveniently use the mobile device to signal to a group of AVs without determining which AV is expected for the user while also providing a means for the appropriate AV to determine a location of the user and navigate to stop at the user.

While this example suggests a particular mobile device may signal a particular AV for a particular control action, in other examples, different types of control actions are based on different encoded signals or other conditions. In one example, the encoded signal may also be used to provide access to the autonomous vehicle. For example, the AV may initially detect the encoded signal to navigate to a stopping point as discussed with respect to FIG. 4. The user may then approach the AV and use the mobile device and encoded signal as authorization to access the AV. The AV may monitor the position of the mobile device (e.g., via the movement of the encoded signal) and the distance of the mobile device to the AV. When the position of the mobile device is within a threshold distance (and providing the appropriate encoded signal), the AV may provide access to the AV, e.g., by unlocking a passenger cabin or storage space of the AV. This may enable the encoded signal to be used for multiple purposes—such as for both navigation of the AV to stop more precisely near a user and to provide access to the vehicle. This may also provide additional security in crowded areas to ensure that only the appropriate mobile device may grant access to the AV.

In additional examples, the position of the mobile device may be monitored to identify movements or motions of the AV that may represent gestures to select a control action for the vehicle. For example, a gesture raising the mobile device may indicate moving towards the location of the device more slowly. As another example, while individual signals may be registered for individual trips, additional signals may be registered without respect to particular trips. These registered signals may be used to provide external control of the vehicle by authorized persons, such as a technician of the AV or emergency personnel. Particular signals may thus represent a “master key” that may be used to provide control of the AV in different ways. For example, one registered signal may be associated with a control action of “pass the detected location on the right side,” while another signal may be associated with “pass the detected location on the left side” or “stop 1 meter in front of the location of this signal.” The associated signals may be registered to AVs and distributed to emergency personnel to control AVs encountered by the personnel. This may be useful, for example, to direct the AV with respect to a road hazard or around an accident.

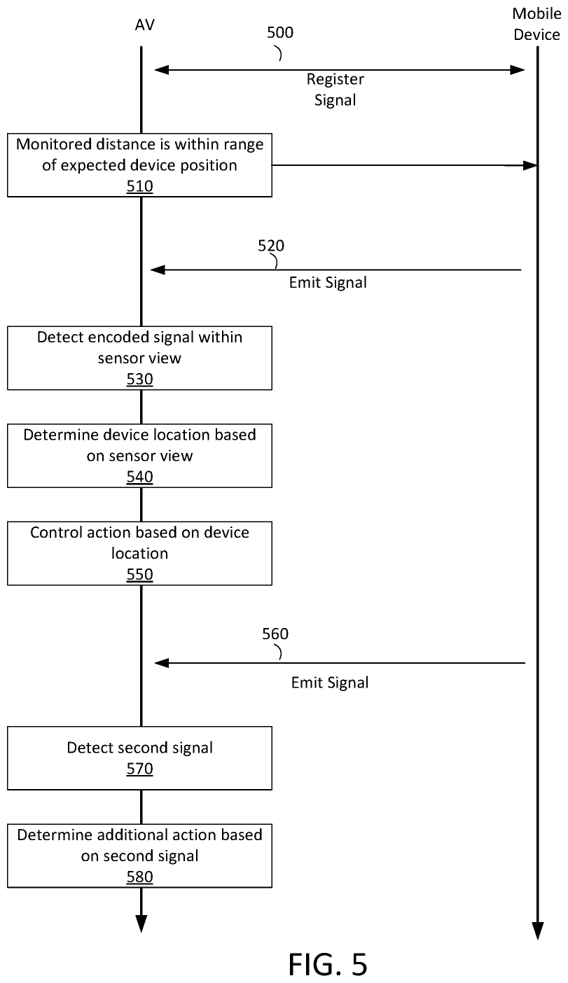

FIG. 5 is an interaction diagram between a mobile device and an AV, according to one embodiment. In this example, the mobile device registers 500 a signal with the AV. As noted above, the signal may be registered in conjunction with an external system (not shown) that coordinates interactions between mobile devices and AVs. The signal may be determined by the mobile device or the AV and shared between them, such that the registered signal reflects the expected signal to be received from the mobile device. In some embodiments, as shown in FIG. 5, the AV may monitor 510 its distance to the expected position of the mobile device (e.g., as an original destination for the route), and send a message to the mobile device when the AV is within a range or distance of the expected position. The message may be used to indicate to the mobile device when to begin emitting the encoded signal. In some embodiments when the mobile device receives the message indicating the AV is within range, the mobile device notifies the user and indicates to the user that the AV is nearby. The mobile device may also inform the user to place the mobile device in a position viewable by the AV (e.g., to raise the mobile device high). The mobile device may automatically, or in response to an input by the user, begin to emit 520 the encoded signal.

When the AV is near the mobile device, the AV may then detect 530 the encoded signal within the sensor view. In some embodiments, the AV attempts to continuously detect relevant encoded signals; in other embodiments, the AV may process the sensor view to identify encoded signals only when the AV expects to be within range of an encoded signal; e.g., after notifying the mobile device that the monitored distance 510 to the expected location of the mobile device is within range. When the encoded signal is detected 530, it may be compared with the registered signals to verify that the encoded signal is registered and authorized to control the AV. For example, as shown in FIG. 4, multiple encoded signals may be detected in the sensor view and the comparison with the registered signals may be used to determine which of the detected encoded signals may affect control of the AV. When the encoded signal is verified, the location of the device emitting the registered signal may be determined 540 in the sensor view and may also be determined with respect to the environment (e.g., in conjunction with other sensor data) to identify the location of the mobile device, which may then be used in the control action 550.

As noted above, in further embodiments additional actions may also be taken by the AV based on continued detection (or second detection) of the emitted signal. For example, the mobile device may continue to emit 560 the signal as the device approaches the AV. When the second signal is detected 570 (or the same signal continues to be detected over time), the AV may determine 580 and perform an additional action. As an example, the initial control action from the encoded signal may be used to identify a stopping point for the AV based on the detected location of the mobile device, while the additional action may be to provide access to the vehicle when the mobile device is within a threshold distance from the AV. As such, the encoded signal may be used to provide location detection for location-based control of the AV.

### Example Embodiments

Various embodiments of claimable subject matter includes the following examples.

Example 1 provides a method for detecting an encoded signal within a sensor view captured by a sensor of an autonomous vehicle; verifying the encoded signal is authorized to affect control of the autonomous vehicle; and responsive to verifying the encoded signal: determining a location of a device emitting the encoded signal; and performing a control action of the automated vehicle based on the determined location of the device.

Example 2 provides for the method of example 1, further including determining a distance of the autonomous vehicle to an expected location of the device; and wherein the encoded signal is detected after the distance is below a threshold.

Example 3 provides for the method of any of examples 1-2, further comprising exchanging the encoded signal with the device.

Example 4 provides for the method of any of example 1-3, wherein verifying the encoded signal includes matching the encoded signal to one or more registered signals and determining the control action based on the match.

Example 5 provides for the method of any of examples 1-4, further including monitoring the location of the device in the sensor view and identifying a motion of the device in the sensor view; and wherein the control action is based on the motion of the device.

Example 6 provides for the method of any of examples 1-5, wherein the control action comprises navigating the autonomous vehicle to a stopping position based on the determined location of the device.

Example 7 provides for the method of any of examples 1-6, further comprising: determining the location of the device is within a threshold distance; and wherein the control action comprises providing access to the autonomous vehicle.

Example 8 provides for a non-transitory computer-readable medium containing instructions executable by one or more processors for: detecting an encoded signal within a sensor view captured by a sensor of an autonomous vehicle; verifying the encoded signal is authorized to affect control of the autonomous vehicle; and responsive to verifying the encoded signal: determining a location of a device emitting the encoded signal; and performing a control action of the automated vehicle based on the determined location of the device.

Example 9 provides for the non-transitory computer-readable medium of example 8, further including determining a distance of the autonomous vehicle to an expected location of the device; and wherein the encoded signal is detected after the distance is below a threshold.

Example 10 provides for the non-transitory computer-readable medium of any of examples 8-9, wherein the instructions are further executable for exchanging the encoded signal with the device.

Example 11 provides for the non-transitory computer-readable medium of any of examples 8-10, wherein verifying the encoded signal includes matching the encoded signal to one or more registered signals and determining the control action based on the match.

Example 12 provides for the non-transitory computer-readable medium of any of examples 8-11, including monitoring the location of the device in the sensor view and identifying a motion of the device in the sensor view; and wherein the control action is based on the motion of the device.

Example 13 provides for the non-transitory computer-readable medium of any of examples 8-12, wherein the control action comprises navigating the autonomous vehicle to a stopping position based on the determined location of the device.

Example 14 provides for the non-transitory computer-readable medium of any of examples 8-13, determining the location of the device is within a threshold distance; and wherein the control action comprises providing access to the autonomous vehicle.

Example 15 provides for a system including: detecting an encoded signal within a sensor view captured by a sensor of an autonomous vehicle; verifying the encoded signal is authorized to affect control of the autonomous vehicle; and responsive to verifying the encoded signal: determining a location of a device emitting the encoded signal; and performing a control action of the automated vehicle based on the determined location of the device

Example 16 provides for the system of example 15, further including determining a distance of the autonomous vehicle to an expected location of the device; and wherein the encoded signal is detected after the distance is below a threshold.

Example 17 provides for the system of any of examples 15-16, wherein the instructions are further executable for exchanging the encoded signal with the device.

Example 18 provides for the system of any of examples 15-17, wherein verifying the encoded signal includes matching the encoded signal to one or more registered signals and determining the control action based on the match.

Example 19 provides for the system of any of examples 15-18, including monitoring the location of the device in the sensor view and identifying a motion of the device in the sensor view; and wherein the control action is based on the motion of the device.

Example 20 provides for the system of any of examples 15-19, wherein the control action comprises navigating the autonomous vehicle to a stopping position based on the determined location of the device.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Specifications, dimensions, and relationships outlined herein (e.g., the number of processors, logic operations, etc.) have been offered for purposes of example and teaching only. Such information may be varied considerably without departing from the spirit of the present disclosure or the scope of the appended claims. In the foregoing description, various non-limiting example embodiments have been described with reference to particular arrangements of components. Various modifications and changes may be made to such embodiments without departing from the scope of the appended claims. This description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along with similar design alternatives, any of the illustrated components, modules, and elements of the figures may be combined in various possible configurations, all of which are clearly within the broad scope of this disclosure.

Note that in this specification, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like, are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
detecting an encoded signal within a sensor view captured by a sensor of an autonomous vehicle;
verifying the encoded signal is authorized to affect control of the autonomous vehicle; and
responsive to verifying the encoded signal:
determining a location of a device emitting the encoded signal; and
performing a control action of the automated vehicle based on the determined location of the device.

2. The method of claim 1, further comprising:
determining a distance of the autonomous vehicle to an expected location of the device; and
wherein the encoded signal is detected after the distance is below a threshold.

3. The method of claim 1, further comprising exchanging the encoded signal with the device.

4. The method of claim 1, wherein verifying the encoded signal includes matching the encoded signal to one or more registered signals and determining the control action based on the match.

5. The method of claim 1, further comprising:
monitoring the location of the device in the sensor view and identifying a motion of the device in the sensor view; and
wherein the control action is based on the motion of the device.

6. The method of claim 1, wherein the control action comprises navigating the autonomous vehicle to a stopping position based on the determined location of the device.

7. The method of claim 1, further comprising:
determining the location of the device is within a threshold distance; and
wherein the control action comprises providing access to the autonomous vehicle.

8. A non-transitory computer-readable medium containing instructions executable by one or more processors for:
detecting an encoded signal within a sensor view captured by a sensor of an autonomous vehicle;
verifying the encoded signal is authorized to affect control of the autonomous vehicle; and
responsive to verifying the encoded signal:
determining a location of a device emitting the encoded signal; and
performing a control action of the automated vehicle based on the determined location of the device.

9. The computer-readable medium of claim 8, wherein the instructions are further executable for:
determining a distance of the autonomous vehicle to an expected location of the device; and
wherein the encoded signal is detected after the distance is below a threshold.

10. The computer-readable medium of claim 8, wherein the instructions are further executable for exchanging the encoded signal with the device.

11. The computer-readable medium of claim 8, wherein verifying the encoded signal includes matching the encoded signal to one or more registered signals and determining the control action based on the match.

12. The computer-readable medium of claim 8, wherein the instructions are further executable for:
monitoring the location of the device in the sensor view and identifying a motion of the device in the sensor view; and
wherein the control action is based on the motion of the device.

13. The computer-readable medium of claim 8, wherein the control action comprises navigating the autonomous vehicle to a stopping position based on the determined location of the device.

14. The computer-readable medium of claim 8, wherein the instructions are further executable for:
determining the location of the device is within a threshold distance; and
wherein the control action comprises providing access to the autonomous vehicle.

15. A system comprising:
a processor; and
a non-transitory computer-readable storage medium containing instructions for execution by the processor for:
detecting an encoded signal within a sensor view captured by a sensor of an autonomous vehicle;
verifying the encoded signal is authorized to affect control of the autonomous vehicle; and
responsive to verifying the encoded signal:
determining a location of a device emitting the encoded signal; and
performing a control action of the automated vehicle based on the determined location of the device.

16. The system of claim 15, wherein the instructions are further executable for:
determining a distance of the autonomous vehicle to an expected location of the device; and
wherein the encoded signal is detected after the distance is below a threshold.

17. The system of claim 15, wherein the instructions are further executable for exchanging the encoded signal with the device.

18. The system of claim 15, wherein verifying the encoded signal includes matching the encoded signal to one or more registered signals and determining the control action based on the match.

19. The system of claim 15, wherein the instructions are further executable for:
monitoring the location of the device in the sensor view and identifying a motion of the device in the sensor view; and
wherein the control action is based on the motion of the device.

20. The system of claim 15, wherein the control action comprises navigating the autonomous vehicle to a stopping position based on the determined location of the device.
